(19) United States
(12) Patent Application Publication
(10) Pub. No.: US 2002/0048277 A1
(43) Pub. Date: Apr. 25, 2002

(54) Packetized data discard

(76) Inventor: Jon C.R. Bennett, Sudbury, MA (US)

Correspondence Address: MINTZ, LEVIN, COHN, FERRIS,, GLOVSKY and POPEO, P.C., One Financial Center, Boston, MA, 02111, US

(21) Appl. No.: 09/845,541

(22) Filed: Apr. 30, 2001

Related U.S. Application Data
(60) Provisional application No. 60/201,059, filed on May 1, 2000.

(51) Int. Cl. H04L 12/28

(52) U.S. Cl. 370/412; 370/415

(57) ABSTRACT

An apparatus for transferring packetized data includes an input for receiving packetized data, a memory coupled to the input and configured to store the packetized data in queues, each queue having an associated size, an output for transmitting the packetized data coupled to the memory, and a controller operatively coupled to the memory and configured to control transfer of the packetized data from the memory to the output, the controller being configured to determine which of multiple of ranges of sizes of queues has the largest range of sizes of queues and at least one associated queue, and to discard packetized data of a selected queue from among the at least one associated queue.

### CROSS-REFERENCE TO RELATED APPLICATIONS

This application claims the benefit of U.S. Provisional Application Ser. No. 60/201,059 entitled “PACKETIZED DATA DISCARD” and filed May 1, 2000.

### BACKGROUND OF THE INVENTION

The invention relates to communications and more particularly to packet discard in packet-switched data networks.

In packet-switched networks, packets of digitized data are sent from a source to a destination, often in different routes depending upon capabilities and availabilities of different network links between the source and the destination. Data are routed through links that connect network nodes, e.g., routers, distributed throughout the network both physically and logically. Data can be sent across various links stemming from a node.

Nodes have limited capacities for amounts of data that they are able to transfer, and temporarily store for transfer. When the capacity (bandwidth and/or buffer space) of a node is exceeded by having too much data (in any combination of numbers of packets and sizes of packets) coming into the node, packets can be discarded to reduce the amount of data to be transferred out of the node, or stored by the node, to within the capacity of the particular node. Which packet(s) to discard can be determined in various ways, including by selecting the longest queue.

In implementing a Longest Queue Discard (LQD) policy for packet networks, the identity of the longest queue in the system can be determined at various points in the system. The time required to perform this function can be a limiting factor in the processing speed of a buffer in the system. Normally the determination of the largest queue in a set is performed by a priority queue (or heap) that serves as a sorting function. Priority queue implementations, however, tend to require O(log₂N) operations (e.g., arithmetic (addition, subtraction, etc.) logical (e.g., comparisons), or data structure manipulations (e.g., memory accesses)) to perform the functions of inserting, deleting or modifying elements in the priority queue to determine the longest queue. In other words, priority queue implementations linearly increase in time required with the number of elements N. In general, memory accesses have the largest impact on performance.

### SUMMARY OF THE INVENTION

Embodiments of the invention provide techniques for discarding longer queues of data from among many queues of data. Queues are sorted into categories or groups according to their lengths. The categories can have the same or different sizes or size ranges, e.g., the same percentage size range. For example, the size of each category can be from a particular size (e.g., 64 Kbytes) to twice that particular size (e.g., 128 Kbytes). Within each category or group, the queues may or may not be sorted according to size. When node capacity is exceeded and a queue is to be discarded, the group that is associated with the largest range of queues that is non-empty is selected and a queue is discarded from that group. The discarded queue may or may not be the largest queue within the group. The queue from a chosen category can be selected in a variety of ways, e.g., randomly or the first-listed queue in the group (e.g., at the top of a storage stack). The size range of the groups can be varied to reduce the possible difference in size between the discarded queue and the actual longest queue in the group. That is, ranges of groups dictate that the smallest possible queue in a given group is within a predetermined size difference of the largest possible queue in the given group, and the ranges can be chosen/designed to reduce the predetermined size difference to acceptable levels.

In general, in an aspect, the invention provides an apparatus for transferring packetized data, the apparatus including an input for receiving packetized data, a memory coupled to the input and configured to store the packetized data in queues, each queue having an associated size, an output for transmitting the packetized data coupled to the memory, and a controller operatively coupled to the memory and configured to control transfer of the packetized data from the memory to the output, the controller being configured to determine which of multiple of ranges of sizes of queues has the largest range of sizes of queues and at least one associated queue, and to discard packetized data of a selected queue from among the at least one associated queue.

Implementations of the invention may include one or more of the following features. The controller is configured to discard packetized data by de-allocating a portion of the memory storing the packetized data. The controller is configured to discard packetized data by reallocating a portion of the memory storing the packetized data. The controller is further configured to determine whether a capacity of the node is exceeded, and wherein the controller is configured to determine which of a plurality of ranges of sizes of queues has the largest range of sizes of queues and at least one associated queue in response to determining that the capacity of the node is exceeded. The controller is configured to select the queue from which to discard data independently of a size of the selected queue relative to sizes of other queues having sizes within the same range of sizes as the selected queue. The controller comprises a processor configured to execute software instructions. The controller comprises hardware configured to operate substantially independently of software instructions.

In general, in another aspect, the invention provides a system for transferring packetized data, the system including an input for receiving packetized data, a memory coupled to the input and configured to store the packetized data in queues, each queue having an associated size, an output for transmitting the packetized data coupled to the memory, and control means operatively coupled to the memory for discarding at least one packet of data from a particular queue associated with a particular range of queue sizes that is larger than any other range of queue sizes that has at least one associated queue.

Implementations of the invention may include one or more of the following features. The control means discards the at least one packet of data independently of a size of the particular queue relative to a size of any other queue associated with the particular range of queue sizes. The control means de-allocates a portion of the memory storing the at least one packet that is discarded. The control means re-allocates the portion of the memory storing the at least one packet that is discarded.

In general, in another aspect, the invention provides a method including storing queues of packetized data in a network node for transfer from the network node and indicia of sizes of the queues, determining which of a plurality of ranges of sizes of queues has the largest range of sizes of queues and at least one associated queue, and discarding packetized data of a selected queue from among the at least one associated queue.

Implementations of the invention may include one or more of the following features. The discarding includes de-allocating memory storing the packetized data. The discarding includes re-allocating memory storing the packetized data. The method may further include determining whether a capacity of the node is exceeded, and wherein the determining which of a plurality of ranges of sizes of queues has the largest range of sizes of queues and at least one associated queue is determined in response to determining that the capacity of the node is exceeded.

In general, in another aspect, the invention provides a data flow method in a network node that transfers packets of data, the method including storing queues of packetized data in the network node, for transfer from the network node, and indicia of sizes of the queues, associating queues of packetized data with buckets having associated ranges of sizes of queues that can be associated with the buckets, determining which of the buckets is at least partially filled and has the largest associated range of sizes of queues relative to any other bucket that is at least partially filled, selecting a queue from the determined bucket, and discarding packetized data from the selected queue.

Implementations of the invention may include one or more of the following features. The discarding includes de-allocating memory storing the packetized data. The method may further include determining whether a capacity of the node for transferring packetized data is exceeded, and wherein the determining which of the buckets that is at least partially filled has the largest associated range of sizes of queues relative to any other bucket that is at least partially filled is determined in response to determining that the capacity of the node is exceeded.

Various embodiments of the invention may provide one or more of the following advantages. Queues can be selected for discarding with few, e.g., one, operation to determine the queue to discard. Queues can be selected for discarding that are at least within a specified range of the largest queue. Potential size differences between a discarded queue and the largest actual queue can be selected and/or adjusted. A relatively long, but possibly not the longest, queue can be selected for discard with fewer hardware operations than guaranteed selection of the longest queue for discard. Queues can be selected for discard in a relatively constant amount of time despite variations in numbers and sizes of queues.

These and other advantages, and the invention itself, will be more readily apparent from the following figures, description, and claims.

### BRIEF DESCRIPTION OF THE FIGURES

FIG. 1 is a block diagram of a network including nodes and node links.

FIG. 2 is a schematic block diagram of a node of the network shown in FIG. 1.

FIG. 3 is a block diagram of a queue bucket system.

FIG. 4 is a block flow diagram of a process of discarding queues.

### DETAILED DESCRIPTION OF PREFERRED EMBODIMENTS

The invention provides techniques for selecting relatively long data queues for discard from among queues in line for transfer by a packet-switched network node.

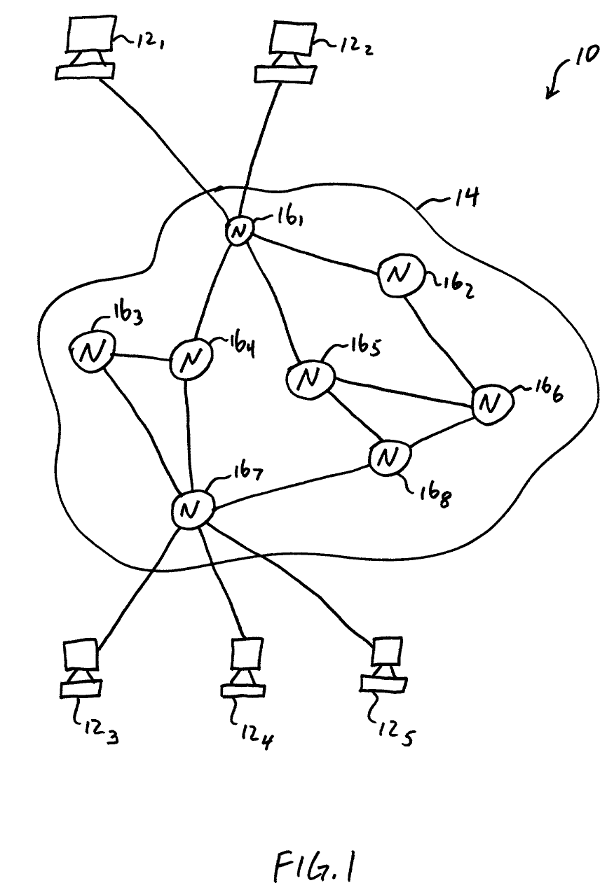

Referring to FIG. 1, a communications system 10 includes personal computers 12₁-12₅, and a network 14 that includes network nodes 16₁-16₈. The computers 12 are connected via appropriate equipment such as modems and appropriate software to the nodes 16₁ and 16₇ as shown. Links 18 connecting the nodes 16 are configured for bi-directional communication. The nodes 16 are routers for transferring packets through the network 14, such as the global packet-switched data network known as the Internet. The nodes 16 are configured to receive packets and route the packets to an adjacent node 16, e.g., as determined by the routing node 16, or within the node itself. The nodes 16 are also configured to buffer the incoming packets as appropriate before transmitting the packets to the adjacent node 16. Nodes 16 have multiple copies of buffering and transferring apparatus such that data can be buffered and transferred internally, and internal buffering and transferring may get congested, just as data buffer and external transfer externally can. The nodes 16 may also be sources and/or destinations of packets.

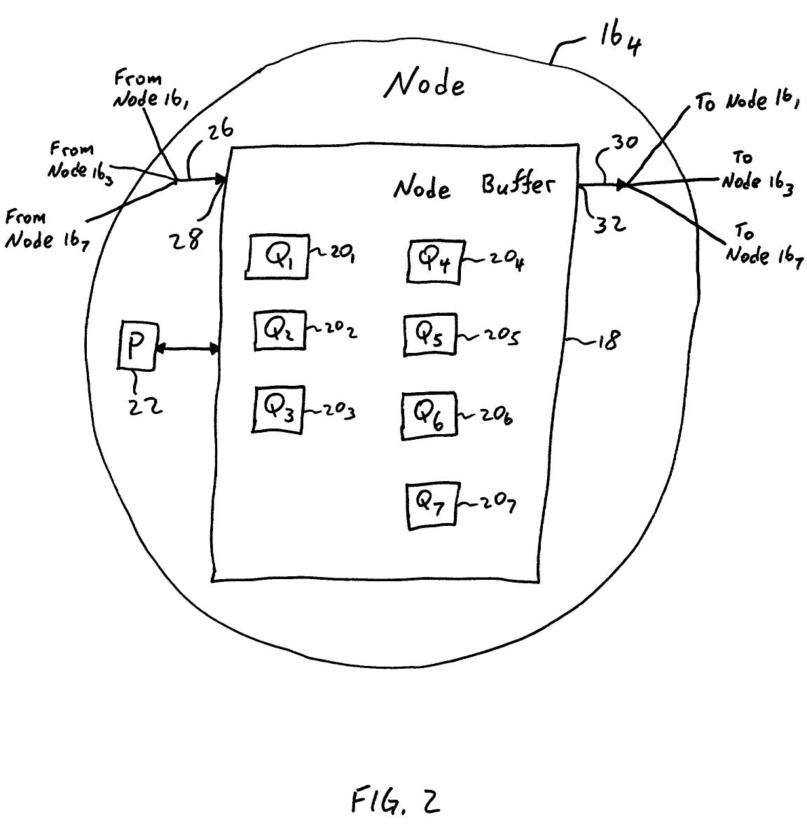

Referring to FIG. 2, an exemplary node 16, here the node 16₄, includes a node buffer 18 that is configured to store and transfer queues 20 of packets of data. The buffer 18 includes memory, for storing data, under the control of a processor 22 executing software. The buffer 18 is connected to receive packets of data from, and transmit packets of data to, the nodes 16₁, 16₃, and 16₇ as shown in FIG. 1, although other connections between nodes 16 are acceptable. Packets are received via an input line 26 at an input port 28 and are transmitted via an output line 30 from an output port 32. Packets of data are stored in the queues 20 (here queues 20₁-20₇ are shown) for transfer out of the buffer 18.

Data packets may be transferred out of the queues 20 in a variety of orders. For example, packets may be transmitted in numerical queue order of Q₁ through Q₇, in parallel according to amounts (that may be different for each queue 20) of bandwidth allocated to each queue 20. Packets may also be transferred in a combination of these techniques such as if queues 20₁-20₃ are transferred in numerical order and queues 20₄-20₇ are transferred in numerical order, but packets from the group of queues 20₁-20₃ and can be transferred in parallel with packets from the group of queues 20₄-20₇ according to bandwidth allocated to the respective groups.

The buffer 18 and processor 22 are configured to perform an approximately Longest Queue Discard (LQD) policy. Preferably, the buffer number space is fixed such that there is a finite size to the buffer memory such that only small positive integers are sorted by the buffer 18 and processor 22. The processor 22 is configured to operate according to software code to control the buffer 18 to perform various functions to implement the approximately LQD. There is a limit on the amount by which an element's (queue's) value (size) may change when it is modified. Packets are added and removed from a queue one at a time, thus the value of an element will only increase or decrease by the maximum size of a packet. Also, an “almost right” answer is assumed to be acceptable. It has been shown that even a coarse approximation for finding the longest queue can have very good performance. Queues 20 are inserted into/removed from the buffer 18 with a limited range of sizes. Queues 20 are put into the system when they go from being empty to having a packet, and are removed when they have no packets. So a newly-inserted queue 20 will have a size greater than 0 and less than or equal to the maximum packet size, and a queue 20 to be removed will have a size of 0.

The buffer 18 is configured to associate the queues 20 in a series of “buckets” corresponding to queues of varying lengths. While the queues 20 can be thought of as being stored in the buckets, the queues 20 need not be physically stored together. The buckets are logical groupings more than physical ones. For example, the buckets may be implemented with pointers, linked lists, or other indicia of which queues 20 belong with which buckets.

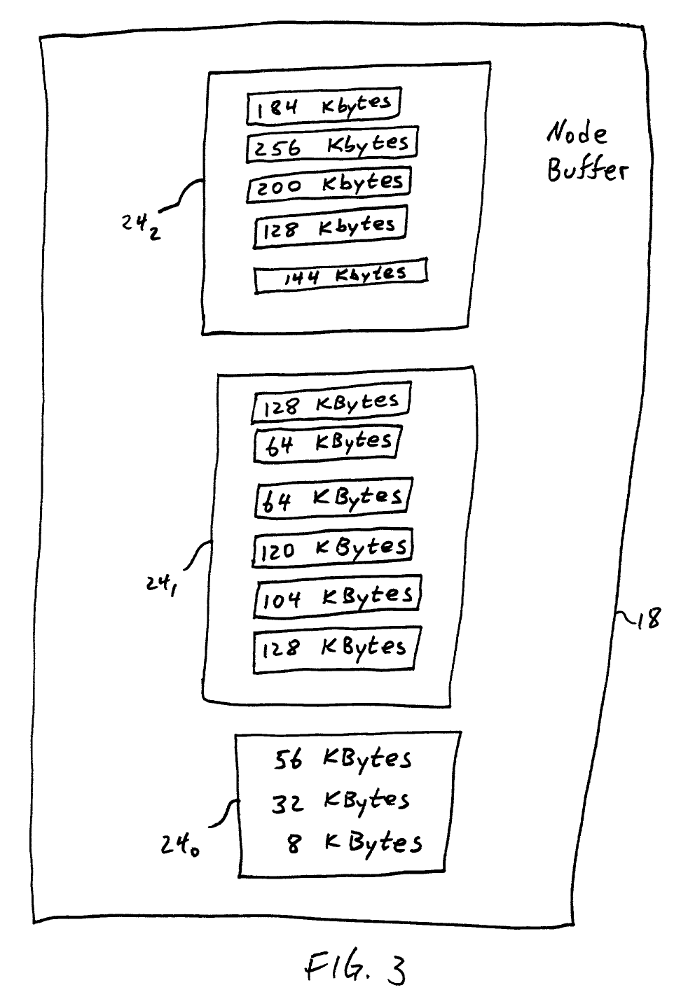

Referring to FIG. 3, the buffer 18 includes n buckets 24₀-24ₙ₋₁, while only three buckets 24₀-24₂ are shown. The maximum sizes of queues 20 that can be associated with the buckets 24 are given by a function S, where Sᵢ denotes the maximum size queue that will be placed in bucket 24ᵢ. The bucket B₀ will contain queues 20 of length 0 bytes to S₀ bytes, bu3cket 24₁ will contain queues 20 of length S₀+1 bytes to S₁ bytes and so on.

The buckets 24, here 24₀, 24₁, and 24₂, store queues 20 of sizes within corresponding size ranges R, here R₀, R₁, and R₂. The size ranges R encompass sizes where the maximum queue size S for a range R is approximately twice the minimum queue size for the range R, except where the minimum queue size is 0. For example, range R₀ includes queues of size 0 bytes to 63 bytes, range R₁ encompasses 64 bytes to 127 bytes, and range R₂ includes queues of 128 bytes to 255 bytes. In other words, R₀=[0 bytes, 63 bytes] and Rᵢ=[2ⁿ bytes, 2ⁿ⁺¹−1 bytes] where n=i+1. To categorize a queue, a binary indication of the size is analyzed to determine the highest bit that is a 1. Other relationships between ranges R than given in this example are acceptable (e.g., different relationships of n to i). The size ranges R of the buckets may be dynamically changed as the average/maximum queue size or size distribution changes. Fixed sizing, however, may provide a simpler implementation.

Queues 20 within any given bucket 24 are not necessarily stored according to their size. The queues 20 may be stored according to their relative sizes, or independently relative to their respective sizes, e.g., according to first arrival, last arrival, or randomly.

The buffer 18 and the processor 22 (FIG. 2) are configured to implement the approximately LQD mechanism to discard queues 20 as appropriate. According to the discard mechanism, the buffer 18 and processor 24 can easily determine which bucket(s) 24 is(are) non-empty (i.e., at least partially filled), identify at least one queue 20 in a bucket 24 that is non-empty, and easily discard one or more packets from any arbitrary queue from a bucket 24. Thus, the queue 20 that gets discarded (i.e., one or more packets of the targeted queue will be discarded) may not be the longest queue 20, but this relative accuracy regarding the longest queue 20 is sufficient to provide relative fairness. How many packets are discarded can vary, but preferably enough packets are discarded such that the capacity of the node 16₄ is not exceeded by the packets that are not discarded. Packets are discarded by de-allocating and/or re-allocating the memory storing the discarded packets such that other data can be written into the de-allocated and/or re-allocated memory. The discard mechanism of the buffer 18 and the processor 22 can also identify queues that are being served very infrequently or not at all, and discard packets from those queues.

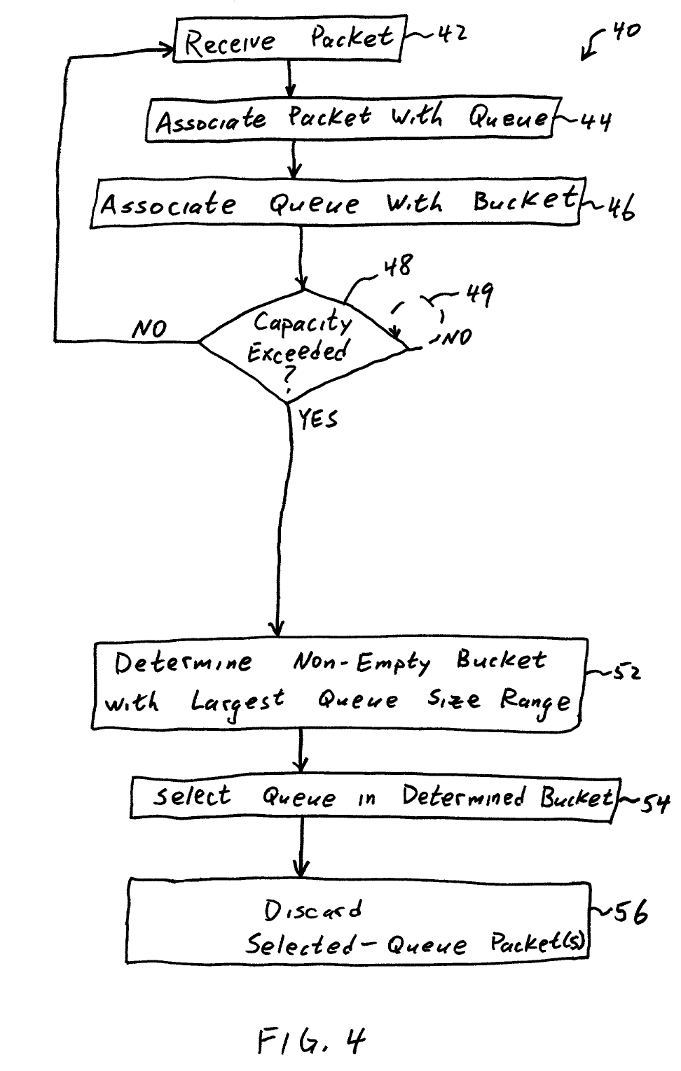

Referring to FIG. 4, with further reference to FIGS. 1-2, a process 40 of discarding packets from queues 20 includes stage 42, 44, and 46, at which, for illustrative (not limiting) purposes, the network node 16₄ receives a data packet and buffers (stores) the packet appropriately At stage 42, the packet is received via the input line 26 and input port 28. Packetized data are stored in an on-going manner in the buffer 18 in one or more queues 20. At stage 44, the received packet is associated with a queue 20, e.g., by being assigned to the queue 20, possibly in accordance with indicia in the packet as to with which other packets the received packet is associated. At stage 46, the received packet is further associated with a queue bucket 24 according to the size of the queue 20 with which the received packet is associated. The bucket 24 with which a queue 20 is associated changes as the size of the queue 20 changes.

At stage 48, the processor 22 determines whether the capacity for storing packets from the node 16₄ is exceeded. This determination could be in response to the packet being received by the node 16₄. If the node's capacity is not exceeded, then the process 40 returns to stage 42 and waits for another packet to be received. Alternatively, the capacity determination could be made periodically, e.g., under control of a timer. In this case, as indicated by a dashed loop 49, if the node's capacity is not exceeded, then the process 40 remains at stage 48. If the node's capacity is exceeded, then the process 40 proceeds to stage 52.

At stage 52, the processor 22 determines which bucket 24 is non-empty and has the largest queue size range R. For example, the processor can query each bucket 24 in descending queue size range R order until a non-empty bucket 24 is found.

At stage 54, a queue 20 in the bucket 24 with the largest queue size range R that is non-empty is selected for discard. The processor 22 randomly, or otherwise, selects the queue 20 in the bucket 24 without regard to whether the selected queue 20 has a larger size relative to any other queue 20 in that bucket 24. Thus, the selected queue 20 may not be the largest queue 20.

At stage 56, a queue 20 selected in stage 54 is discarded. The discarding may include de-queuing the packet for transmission from the node 16₄, or otherwise de-allocating the memory storing the packet or packets to be discarded.

The process 40 shown in FIG. 4 is exemplary and not limiting. Stages may be added, deleted, or rearranged compared to FIG. 4. For example, stage 44 may be eliminated, e.g., if a received packet is associated with a queue as indicated by information in the packet, e.g., in a header of the packet. Also, stages 42, 44, and 46 may be deleted, e.g., if the receipt of a data packet is not used to actuate the discard mechanism.

Other embodiments are within the scope and spirit of the appended claims. For example, functions were described above as being performed/controlled by software. Due to the nature of software, functions may be performed/controlled by software, hardware, firmware, hardwiring, or combinations of any of these and the physical implementations of the functions may physically reside in locations other than that/those described above, including being distributed in various locations. For example, the processor 22 may be implemented as hardware logic (independent of software, or substantially so) to perform the functions described, which may result in faster operation than by using a software-controlled processor. A software-controlled processor may be used for processing data for connections to the outside of the network 14, while hardware may be used for processing data for connections to the inside the network 14. While preferences for the buffer were listed, the buffer number space need not be fixed, the amount by which a queue's size may change when it is modified need not be limited, queues may be inserted into/removed from the buffer need not be within a limited range of sizes, and queues may be put into the system at times other than when they go from empty to having a packet and may be removed when they have at least one packet. Bucket size ranges R may be different than those discussed. The size ranges R could overlap. The degree of increase of one range relative to another can be different than as discussed above. For example, at the lower size ranges, the ranges R may increase in small increments that may or may not be the same (e.g., 64 bytes) while at higher size ranges, the increases are larger, such as the doubling of maximum size similar to that discussed. Preferably, whatever scheme of associating queues 20 with buckets 24 is used, the process(es) of associating the queues 20 and selecting queues 20 for discard is less expensive (in terms of cost and/or processing consumption) than sorting the queues 20 and selecting the largest.

Sizes of queues may be adjusted to effective sizes by applying weighting to one or more of the queues. The effective sizes can be used to associate queues 20 with buckets 24. A minimum/threshold effective size can be used that must be met by the queue 20 in order for the queue 20 to be targeted for pushout. A special bucket may be established for queues 20 with effective sizes below the minimum/threshold, such as those with an effective/weighted size of zero bytes, that have bytes. The special bucket can be used so that such queues can be targeted for discard despite not normally being eligible for discard. The queue targeted for discard could be selected randomly from the special bucket, or a similar mechanism to targeting queues that do meet the minimum/threshold could be applied (e.g., by changing the minimum/threshold).

What is claimed is:

1. An apparatus for transferring packetized data, the apparatus comprising:
an input for receiving packetized data;
a memory coupled to the input and configured to store the packetized data in queues, each queue having an associated size;
an output for transmitting the packetized data coupled to the memory; and
a controller operatively coupled to the memory and configured to control transfer of the packetized data from the memory to the output, the controller being configured to determine which of a plurality of ranges of sizes of queues has the largest range of sizes of queues and at least one associated queue, and to discard packetized data of a selected queue from among the at least one associated queue.

2. The apparatus of claim 1 wherein the controller is configured to discard packetized data by de-allocating a portion of the memory storing the packetized data.

3. The apparatus of claim 1 wherein the controller is configured to discard packetized data by re-allocating a portion of the memory storing the packetized data.

4. The apparatus of claim 3 wherein the controller is further configured to determine whether a capacity of the node is exceeded, and wherein the controller is configured to determine which of a plurality of ranges of sizes of queues has the largest range of sizes of queues and at least one associated queue in response to determining that the capacity of the node is exceeded.

5. The apparatus of claim 1 wherein the controller is configured to select the queue from which to discard data independently of a size of the selected queue relative to sizes of other queues having sizes within the same range of sizes as the selected queue.

6. The apparatus of claim 1 wherein the controller comprises a processor configured to execute software instructions.

7. The apparatus of claim 1 wherein the controller comprises hardware configured to operate substantially independently of software instructions.

8. A system for transferring packetized data, the system comprising:
an input for receiving packetized data;
a memory coupled to the input and configured to store the packetized data in queues, each queue having an associated size;
an output for transmitting the packetized data coupled to the memory; and
control means operatively coupled to the memory for discarding at least one packet of data from a particular queue associated with a particular range of queue sizes that is larger than any other range of queue sizes that has at least one associated queue.

9. The system of claim 8 wherein the control means discards the at least one packet of data independently of a size of the particular queue relative to a size of any other queue associated with the particular range of queue sizes.

10. The system of claim 9 wherein the control means de-allocates a portion of the memory storing the at least one packet that is discarded.

11. The system of claim 10 wherein the control means re-allocates the portion of the memory storing the at least one packet that is discarded.

12. A method comprising:
storing queues of packetized data in a network node for transfer from the network node and indicia of sizes of the queues;
determining which of a plurality of ranges of sizes of queues has the largest range of sizes of queues and at least one associated queue; and
discarding packetized data of a selected queue from among the at least one associated queue.

13. The method of claim 12 wherein the discarding includes de-allocating memory storing the packetized data.

14. The method of claim 12 wherein the discarding includes re-allocating memory storing the packetized data.

15. The method of claim 14 further comprising determining whether a capacity of the node is exceeded, and wherein the determining which of a plurality of ranges of sizes of queues has the largest range of sizes of queues and at least one associated queue is determined in response to determining that the capacity of the node is exceeded.

16. A data flow method in a network node that transfers packets of data, the method comprising:
storing queues of packetized data in the network node, for transfer from the network node, and indicia of sizes of the queues;
associating queues of packetized data with buckets having associated ranges of sizes of queues that can be associated with the buckets;
determining which of the buckets is at least partially filled and has the largest associated range of sizes of queues relative to any other bucket that is at least partially filled;
selecting a queue from the determined bucket; and
discarding packetized data from the selected queue.

17. The method of claim 16 wherein the discarding includes de-allocating memory storing the packetized data.

18. The method of claim 17 further comprising determining whether a capacity of the node for transferring packetized data is exceeded, and wherein the determining which of the buckets that is at least partially filled has the largest associated range of sizes of queues relative to any other bucket that is at least partially filled is determined in response to determining that the capacity of the node is exceeded.
